(19) United States
(12) Patent Application Publication
(10) Pub. No.: US 2014/0061971 A1
(43) Pub. Date: Mar. 6, 2014

(54) CLAM SHELL PACKAGING AND MOLD FOR MOLDABLE DOUGH

(71) Applicant: American Covers, Inc.,, Draper, UT (US)

(72) Inventor: Bryce Haymond, Pleasant Grove, UT (US)

(21) Appl. No.: 13/838,021

(22) Filed: Mar. 15, 2013

Related U.S. Application Data
(60) Provisional application No. 61/694,912, filed on Aug. 30, 2012.

(51) Int. Cl. B29C 33/42; B29C 43/00

(52) U.S. Cl. CPC B29C 33/424; B29C 43/003
USPC 264/299; 425/318

(57) ABSTRACT

A promotional item has a moldable dough in a container where the container and the moldable dough have a three-dimensional indicia associated with or representing a business and/or a product.

### PRIORITY CLAIM

Priority is claimed to U.S. Provisional Patent Application Ser. No. 61/694,912, filed Aug. 30, 2012, which is hereby incorporated herein by reference.

### BACKGROUND

1. Field of the Invention

The present invention relates generally to promotional items and/or moldable dough.

2. Related Art

Promotional items are typically inexpensive items of functional or whimsical value that carry a product or business name and that can be given away by companies to get their brand in front of viewers or potential users. An example of a functional promotional item is a pen with a business name and contact information thereon. An example of a whimsical promotional item is a puzzle or game also with a business or product name thereon. One challenge is to develop an item that is inexpensive enough that it can be given away in bulk. Another challenge is to develop an item that has perceived value or that can capture interest in order to motivate the user to keep and/or use the item, and thus maintain the brand in view of and/or in use by the user.

### SUMMARY OF THE INVENTION

It has been recognized that it would be advantageous to develop a promotional item that is able to repeatedly place a logo (or other indicia of a business or product) in front of a user for an extended period of time, and/or repeatedly capture the user's attention.

The invention provides a promotional device with a container and a protrusion, an indentation, or both, formed in the container, and forming a three-dimensional indicia indicative of or representing a business, a product, or both, and defining an interior negative mold thereof on an interior of the container. A moldable dough is disposed in the container and abuts the interior negative mold of the base to form an exterior positive impression of the mold in the dough, and thus a three-dimensional indicia indicative of or representing the business, product, or both, in the dough.

In addition, the invention provides a promotional device including a container having a lid with a cavity therein and an opening therein to the cavity. A blank base is coupled to the lid and covers the cavity and closes the opening. The lid and the base form a substantially air-tight compartment in the cavity and define a volume therein. A replacement base is interchangeable with the blank base, and is couplable to the lid and covers the cavity and closes the opening with the blank base removed. The lid and the replacement base form another substantially air-tight compartment in the cavity and define another volume therein. A protrusion, an indentation, or both, are formed in the replacement base and form a three-dimensional indicia indicative of or representing a business, a product, or both, and define an interior negative mold thereof on an interior of the replacement base. A moldable dough is disposed in and substantially fills the another volume of the container and abuts the interior negative mold of the replacement base to form an exterior positive impression of the mold in the dough, and thus a three-dimensional indicia indicative of or representing the business, product, or both, in the dough.

In addition, the invention provides a method for making a promotional device, including obtaining a plurality of precursors. Each precursor includes a container having a lid with a cavity therein and an opening therein to the cavity, and a blank base coupled to the lid and covering the cavity and closing the opening. The lid and the blank base form a substantially air-tight compartment in the cavity and define a volume therein. A moldable dough is disposed in the volume of the container. The method includes embossing or debossing a plurality of replacement bases. Each replacement base includes a protrusion, an indentation, or both, formed in the replacement base and forming a three-dimensional indicia indicative of or representing a business, a product, or both, and defining an interior negative mold thereof on an interior of the replacement base. The method includes removing the blank base from each precursor, and closing each lid with a different one of the plurality of replacement bases. The method includes pressing each replacement base into the dough to impart the interior negative mold of the replacement base into the dough to form an exterior positive impression of the mold in the dough, and thus a three-dimensional indicia indicative of or representing the business, product, or both, in the dough.

Furthermore, the invention provides a promotional device including a container having a lid with a cavity therein and an opening therein to the cavity. A blank base is coupled to the lid and covers the cavity and closes the opening. The lid and the base form a substantially air-tight compartment in the cavity and define a volume therein. A replacement base is interchangeable with the blank base, and is couplable to the lid and covers the cavity and closes the opening with the blank base removed. The lid and the replacement base form another substantially air-tight compartment in the cavity and define another volume therein. A protrusion, an indentation, or both, are formed in the replacement base and form a three-dimensional indicia indicative of or representing a business, a product, or both, and define an interior negative mold thereof on an interior of the replacement base. A moldable dough is disposed in and substantially fills the another volume of the container and abuts the interior negative mold of the replacement base to form an exterior positive impression of the mold in the dough, and thus a three-dimensional indicia indicative of or representing the business, product, or both, in the dough. A closure is disposed between the lid and the replacement base to secure the lid and the replacement base together and to form the substantially air-tight compartment. The closure includes an indentation formed in one of the lid or the replacement base with an annular, inwardly-facing, perimeter wall. A protrusion is formed in another of the lid or the replacement base with an annular, outwardly-facing, perimeter wall abutting to the perimeter wall of the indentation. The protrusion has a depth less than a depth of the indentation, creating a annular space between the protrusion and the indentation. The dough is pressed into the annular space between the protrusion and the indentation, which defines an overflow volume for the dough. A release coating is applied to an interior surface of the lid and the replacement base. At least a portion of the lid, the replacement base, or both is transparent. The moldable dough is visible through the at least a portion of the lid, the replacement base, or both. The moldable dough has at least two locations, including: an enclosed location in which the dough is disposed in the container; and a removed location in which the dough is removed out of the container. The moldable dough is pliable and has at least two configurations, including: a molded configuration in which the dough has the three-dimensional indicia; and a random configuration in which the dough has a random configuration without the three-dimensional indicia.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a top view of a promotional device in accordance with an embodiment of the present invention having a container with a lid and a base, or replacement base, having a protrusion, an indentation, or both formed therein, and forming a three-dimensional indicia indicative of or representing a business, a product, or both, such as a logo;

FIG. 2 is a side view of the promotional device of FIG. 1;

FIG. 3 is a bottom view of the promotional device of FIG. 1;

FIG. 4 is a side view of a precursor of the promotional device of FIG. 1 shown with a blank base that can be removed and replaced with the replacement base;

FIG. 5 is a bottom view of the precursor of the promotional device of FIG. 4 showing the blank base;

FIG. 6 is an exploded side view of the promotional device of FIG. 1 showing a moldable dough in the container;

FIG. 7 is a bottom view of the moldable dough of the promotional device of FIG. 1;

FIG. 8 is a partial side view of the promotional device of FIG. 1 showing a closure between the lid and the base or replacement base with the dough pressed into an annular space of the closure;

FIGS. 9-14 show a method for making the promotional device of FIGS. 4 and 5, where FIGS. 9 and 10 are bottom and side views, respectively, of the precursor, FIG. 11 is a side view of the blank base removed from the precursor, FIG. 12 is a side view of the replacement base, and FIGS. 13 and 14 are bottom and side views, respectively, of the promotional device formed by replacing the blank base of the precursor with the replacement base;

FIGS. 15-17 show various configurations of the moldable dough, where FIGS. 15 and 16 are bottom and side views, respectively, of the moldable dough in a molded configuration in which the dough has the three-dimensional indicia therein, and removed location in which the dough is removed out of the container, and where FIG. 17 is a bottom view of the moldable dough in a random configuration in which the dough has a random configuration without the three-dimensional indicia;

FIG. 18 is a side view of the moldable dough and the base or the replacement base of the promotional device of FIG. 1 showing the moldable dough being pressed into the three-dimensional indicia or interior negative mold to form an exterior positive impression of the mold in the dough and thus a three-dimensional indicia indicative of or representing the business, product, or both, in the dough;

FIG. 19 is a top view of another precursor of another promotional device in accordance with the present invention showing a label on an interior thereof;

FIG. 20 is an exploded side view of another promotional device in accordance with the present invention showing a lid having a protrusion, an indentation, or both formed therein, and forming a three-dimensional indicia indicative of or representing a business, a product, or both, such as a logo (and defining an interior negative mold thereof on an interior of the lid);

FIG. 21 is a top view of the promotional device of FIG. 20;

FIG. 22 is a bottom view of the promotional device of FIG. 20;

FIG. 23 is a side view of another promotional device in accordance with the present invention showing a base or replacement base having a protrusion, an indentation, or both formed therein, and forming a three-dimensional indicia indicative of or representing a business, a product, or both, such as a logo (and defining an interior negative mold thereof on an interior of the base or replacement base) with the three-dimensional indicia recessed into the base;

FIG. 24 is a side view of another promotional device in accordance with the present invention showing a lid having a protrusion, an indentation, or both formed therein, and forming a three-dimensional indicia indicative of or representing a business, a product, or both, such as a logo (and defining an interior negative mold thereof on an interior of the lid) with the three-dimensional indicia recessed into the lid;

FIG. 25 is a side view of another promotional device in accordance with the present invention showing both a lid and a base having a protrusion, an indentation, or both formed therein, and forming a three-dimensional indicia indicative of or representing a business, a product, or both, such as a logo (and defining an interior negative mold thereof on an interior of the lid and the base) with the three-dimensional indicia recessed into both the lid and the base; and

FIG. 26 is a side view of another promotional device in accordance with the present invention showing both a lid and a base having a protrusion, an indentation, or both formed therein, and forming a three-dimensional indicia indicative of or representing a business, a product, or both, such as a logo (and defining an interior negative mold thereof on an interior of the lid and the base) with the three-dimensional indicia protruding from both the lid and the base.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

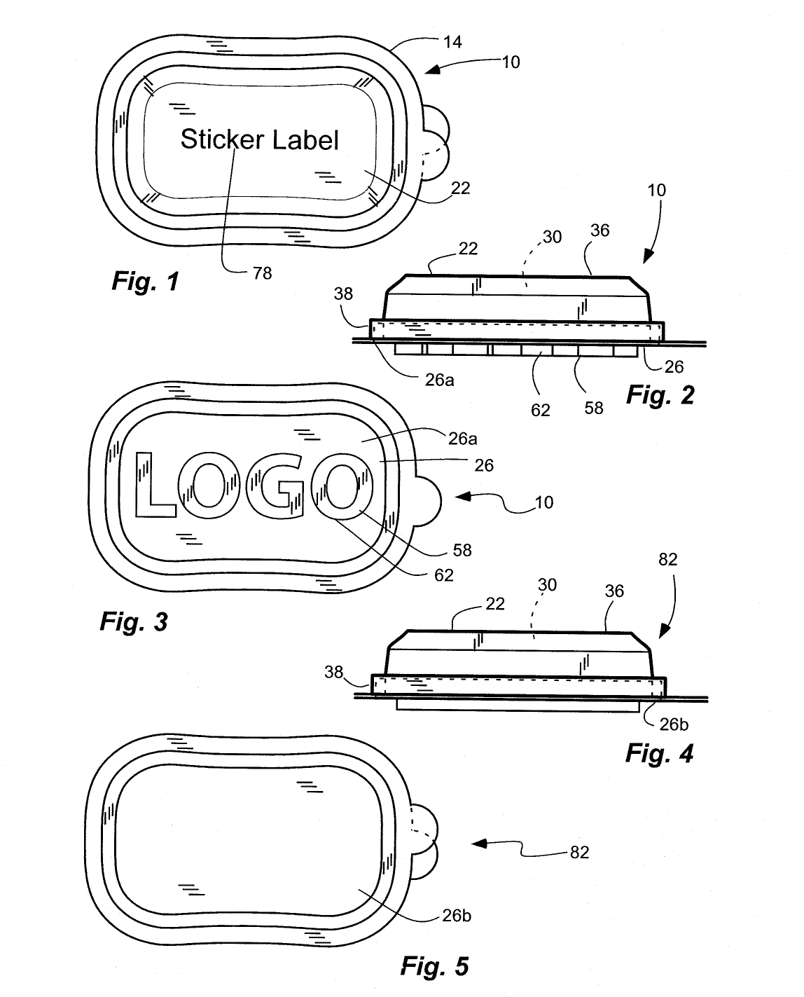

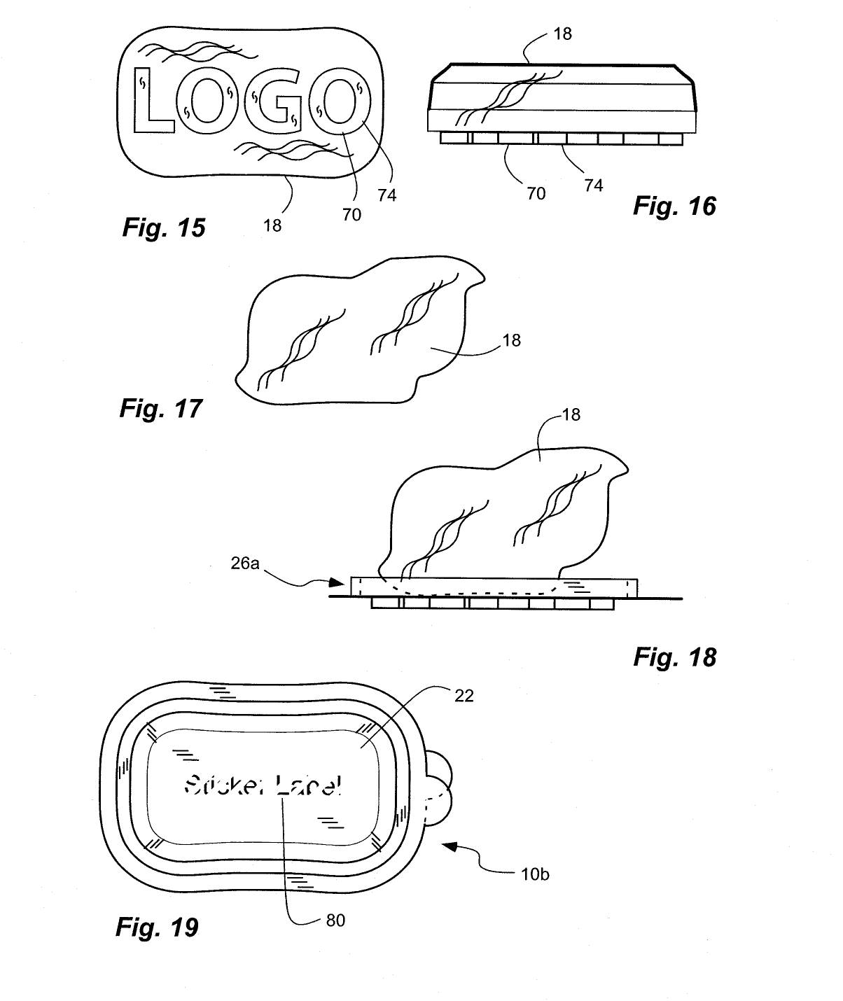

Referring to FIGS. 1-17, a promotional item or device, indicated generally at 10, in an example implementation in accordance with the invention is shown. The promotional item 10 can be provided by businesses, corporations or other organizations, with indicia indicative of or representing a business (or company or organization), a product or service, or both, such as a logo, message, slogan, etc. In addition, a plurality of precursors can be provided that can be customized to have the indicia.

The promotional item 10 includes a container 14 containing a moldable dough 18. The moldable dough 18 can be flexible, malleable and/or pliable under manual exertion (i.e. by hand without the need for tools or machines). Thus, the dough 18 can be removed from the container 14 and molded as desired by a user. The moldable dough can be any type of commercially available dough. In addition, the dough can be: any appropriate color, including brightly colored with standard, pastel or florescent colors and/or brightness. In one aspect, the color of the dough can correspond to a logo, or business or product indicia, as described below. In another aspect, the dough can include two or more separate and discrete colors, such as by including two or more separate and discrete bodies of the dough adjacent one another in the container. In another aspect, the dough can be or can contain a phosphorous material, or like substance, such as Zinc Sulfide and Strontium Aluminate, so that it can glow. In another aspect, the dough can have inclusions, such as small plastic novelties or logos. The inclusions can have a different consistency than the dough. In another aspect, the dough can include a scent material, different from the natural scent of the dough itself, to give a more aesthetically pleasing fragrance to the dough. In another aspect the dough can include an anti-bacterial agent. The dough can be of the type that does not flack or crumble, but that maintains coherence. In addition, the dough can be of the type that dries in air over time to a rigid or hardened form. Alternatively, the dough can remain pliable in air over time.

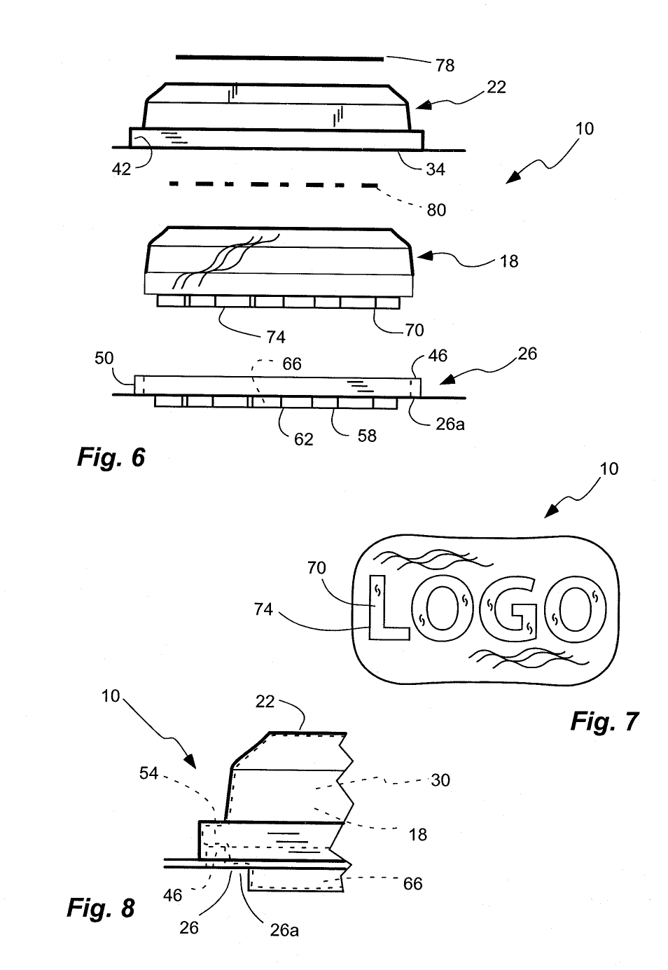

The container 14 can have a lid 22 and a base 26 (a blank base and/or a replaceable base as described in greater detail below). The lid 22 can have a cavity 30 therein and an opening 34 (FIG. 6) therein to the cavity. The lid can have a dome shape with a wider bottom and a narrower top. Thus, the lid can be an inverted vessel. A top 36 of the lid 22 can be flat or have a flat portion so that the lid can be inverted and disposed on a support surface.

The base 26 is coupled to the lid 22 and covers the cavity 30 and closes the opening 34. Thus, the base 26 is like a lid on a vessel. (In one aspect, the lid 22 can be termed a bowl or vessel, and the base 26 can be termed a lid or cover. In another aspect, the configuration of the container can be inverted to that shown. As such, terms herein such as up or down or raised, etc., are relative.) The lid 22 and the base 26 can together form a substantially air-tight compartment in the cavity 30, and define a volume therein. In another aspect, the lid, or the lid and the base, can form more than one cavity with dough in each one of the cavities. Thus, the lid can have interior walls separating the cavity into multiple cavities. Similarly, base can have partitions that can correspond to the interior walls of the lid. The dough in the different cavities can have different characteristics, such as different colors, etc. The container, and/or the lid and the base, can have various different shapes and sizes, including a shape matching or corresponding to the indicia or logo described below. Both the lid and the base can include a perimeter flange extending laterally outwardly around a perimeter of the lid and base.

The container 14 can have a closure, or the lid 22 and the base 26 can have a closure therebetween, to secure the lid and the base together and to form the substantially air-tight compartment. The closure can include an indentation 38 formed in one of the lid or the base (such as the lid 22, as shown) with an annular, inwardly-facing, perimeter wall 42 (FIGS. 6 and 8). The closure can include a protrusion 46 formed in another of the lid or the base (such as the base 26 as shown) with an annular, outwardly-facing, perimeter wall 50 abutting to the perimeter wall of the indentation (FIGS. 6 and 8). (It is understood that the indentation can be formed in the base and the protrusion can be formed in the lid, opposite of that shown.) The walls 42 and 50 can form an interference fit or a press fit, as understood in the art. In addition, the walls can include a mating bead and groove, also as understood in the art. The lid and base can form a snap seal, or can be sealed separately. The protrusion 46 can have a depth less than a depth of the indentation 38 to create an annular space 54 (FIG. 8) between the protrusion and the indentation. The annular space can define an overflow or spillway, as discussed in further detail below. In addition, the container 14, or the lid 22 and the base 26, can have a pair of off-set tabs, each extending from a different one of the lid and the base, to facilitate separation of the base from the lid. Furthermore, the container, or the lid and the base, can be any shape and size, including rectangular, circular, oval, etc. The shape of the container can correspond to a logo.

The container, or the lid and the base, can be formed of or can include a PVC plastic, and can define a clamshell or clamshell type container. The container, or the lid and the base, can be formed of a single layer of plastic with a substantially constant thickness, with protrusions on one side corresponding to indentations on the other, and vise versa. The lid and the base may be formed by vacuum forming. A release coating can be applied to an interior surface of the lid 22 and/or the base 26 to resist the dough 18 sticking to the container 14 of interior surfaces thereof. The release coating can be or can include a silicon oil. The lid 22 and/or the base 26, or at least a portion thereof, can be transparent, or at least translucent. Thus, the dough can be viewed through the container or transparent portion thereof. In another aspect, the container, and/or the lid and the base, can be formed of wood, metal, plastic, glass, or another material, and can be opaque.

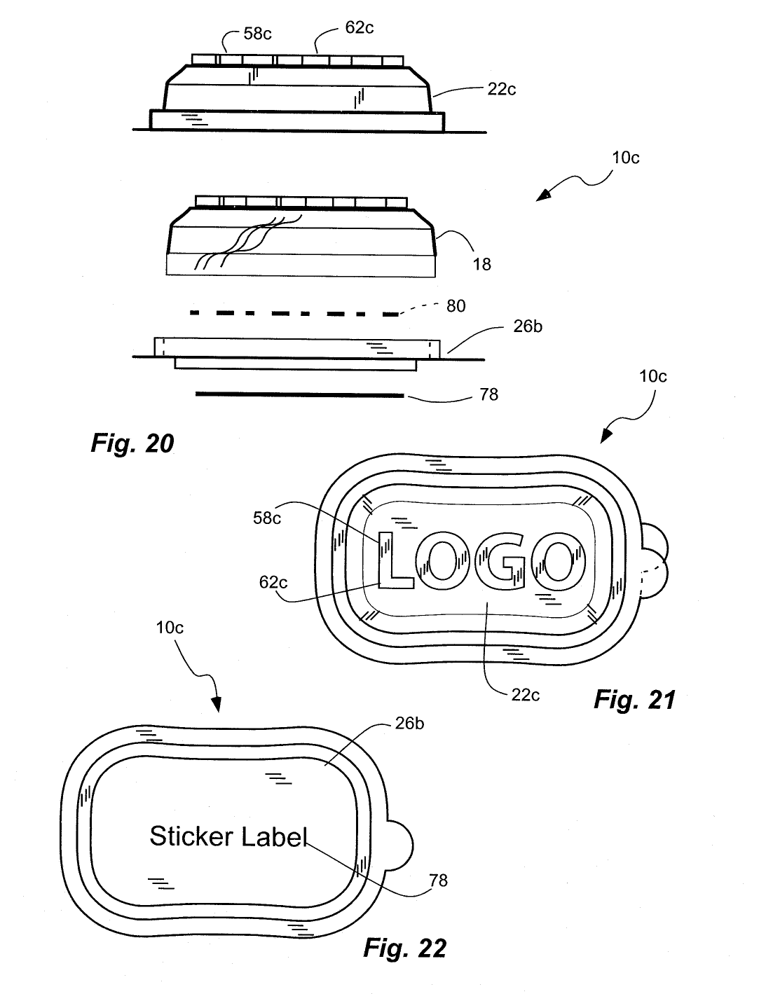

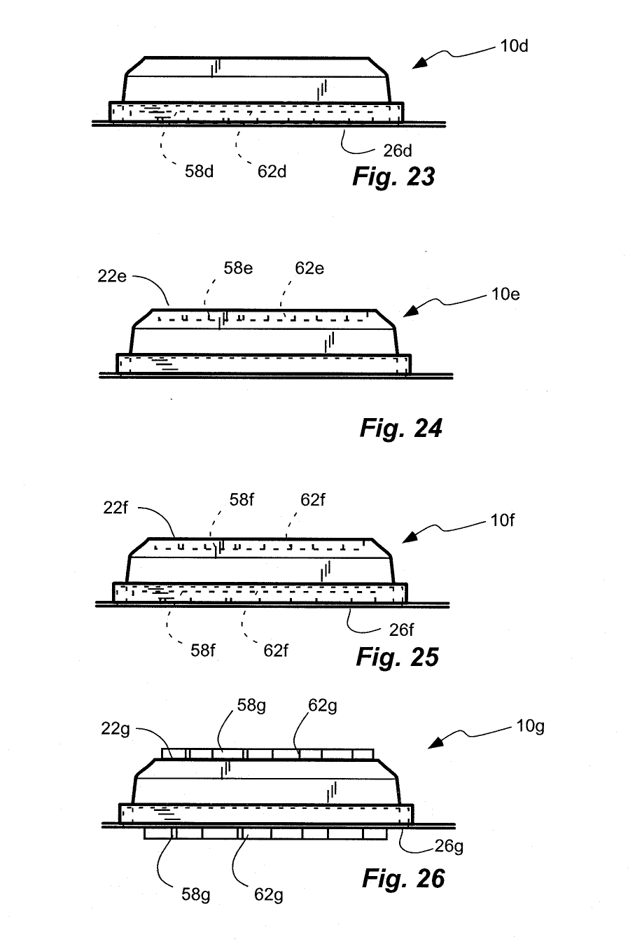

A protrusion, an indentation, or both 58, are formed in the base 26, and forms a three-dimensional indicia 62 indicative of or representing a business (or company), a product, or both, such as a logo, and defines an interior negative mold 66 (FIGS. 6 and 8) thereof on an interior of the base 26. The logo or indicia 62 can be or can include letters, symbols, figures, pictures, logos, art, corporate messages, slogans, bi-lines, icons, etc. that are associated with or that form a representation of a business, company or organization or the like, or a product, service or the like, or both. The logo or indicia 62 can be raised in, indented into, or both, the base 26, or with respect to the outer surface of the base. The indicia 62 can be embossed or raised, or debossed or lowered. The indicia 62 can protrude from a perimeter or outer shell of the container or lid, as shown in FIG. 4. In another aspect, the indicia 62 can be recessed or extending into the perimeter or outer shell of the container or lid, as shown in FIGS. 23-25. In another aspect, a protrusion, an indentation, or both, can be formed in the lid as well, or as opposed to in the base (See FIGS. 20-25). The protrusion and/or indentation can have a thickness, depth and/or elevation between 0.05 mm and 20 mm.

As discussed above, the moldable dough 18 is disposed in and substantially fills the volume or cavity 30 of the container 14. A volume of the dough can match the volume of the container or cavity. The annular space 54 (FIG. 8) discussed above can act as an overflow or spillway for the dough during thermal expansion of the dough and/or thermal contraction of the container, and/or displacement of the dough as discussed in greater detail below. In addition, the dough 18 can abut to the interior negative mold 66 of the base 26 to form an exterior positive impression 70 (FIGS. 6 and 7) of the mold in the dough, and thus a three-dimensional indicia 74 (FIGS. 6 and 7) indicative of or representing the a business, company or organization or the like, or a product, service or the like, or both as discussed above, in the dough.

The moldable dough 18 has at least two locations, including: an enclosed location and a removed location. In the enclosed location, the dough 18 is disposed in the container 14, as shown in FIGS. 1-5. In the removed location, the dough 18 is removed out of the container 14, as shown in FIGS. 6 and 7. In addition, the moldable dough 18 can have at least two configurations, including: a molded configuration and a random configuration. In the molded configuration, the dough 18 has the three-dimensional indicia 74 from the interior negative mold 66 of the base therein, and can have the internal shape of the cavity 30 as well, as shown in FIGS. 6, 7, 15 and 16. The dough 18 can have the molded configuration both in and out of the container 14, or in both the enclosed and removed locations. In the random configuration, the dough 18 has a random configuration without the three-dimensional indicia, as shown in FIG. 17. The dough can have the random configuration outside of the container, or in the removed location, but will be forced into the molded configuration upon return to the container, or in the enclosed location.

The dough 18 can be pressed into the annular space 54 (FIG. 8) between the protrusion 46 and the indentation 42 by the base 26 closing the lid 22. In addition, the container 14 (or lid 22) and/or the base 26, and the interior negative mold 66 of the base, can be used as a tool or toy to form an exterior positive impression 70 of the mold in the dough, and thus a three-dimensional indicia 74 indicative of or representing the business, product, or both, in the dough, when the dough is outside of the container, or in the removed location, as shown in FIG. 18. Thus, the dough does not need to be in the container in order to form the impression or indicia in the dough. Similarly, the container 14 (or lid 22) or the base 26 can be used as a tool or toy to form the impression or indicia in other soft substances, such as sand, mud, clay, bread, other types of dough, or other materials that can retain their shape for an extended period of time, etc. As described above, the dough 18 can be of the type that dries in air over time to a rigid or hardened form. Thus, the impression or indicia 74 formed in the dough 18 can be allowed to dry and harden outside of the container, or in the removed location, to keep the impression or indicia formed in the dough indefinitely. The volume of the lid 22 can be greater than the volume of the base 26, and the dough 18 can tend to stay in the lid when the container 14 is opened. Thus, the impression or indicia 74 formed in the dough 18 in the container 14 can be exposed to a user upon opening of the container.

In addition, the promotional item 10 can include a matching indicia, such as a sticker or label 78, carried by an exterior surface of the lid 22. The matching indicia can correspond to the three-dimensional indicia 62 on the base 26. The indicia or sticker 78 can have an image or the indicia on an adhesive side of the sticker to face against the container or the lid and into the cavity so that the image or indicia is visible on the inside of the lid or cavity (through a transparent lid) when the dough is removed. In another aspect, the promotional item 10 can include a matching indicia, such as a sticker or label 80 (FIGS. 6 and 19) carried by an interior surface of the lid 22. The matching indicia can correspond to the three-dimensional indicia 62 on the base 26. The indicia or sticker 80 can have an image or the indicia on an adhesive side of the sticker to face against the container or the lid and out of the cavity so that the image or indicia is visible on the outside of the lid or cavity (through the transparent lid), as shown in FIG. 19.

As indicated above, the container 14 can have both a blank base 26b and an interchangeable replacement base 26a, as shown in FIGS. 1-5 and FIGS. 9-14. Both bases couple to the lid 22, and cover the cavity 30 and close the opening 34, and form a substantially air-tight compartment in the cavity, and define a volume. The replacement base 26a can include the protrusions and/or indentations 58 and the indicia 62, and can define another volume less than the volume with the blank base. Thus, when the blank base 26b is removed and replaced with the replacement base 26a, the dough 18 can expand into the annular space 54. The blank base 26b may include a bottom portion that is flat but extruded a short distance, i.e. a couple millimeters, from the surrounding flange. The blank base 26b can then be replaced with a different base, i.e. the interchangeable replacement base 26a with the indicia 62, that when pressed onto the open container 14 to close it, the extra space provided by the former blank and flat base 26b will allow the dough to form into the volume of the indicia 62 on the new base 26a. The blank base 26b can be free of a protrusion or an indentation forming a three-dimensional indicia.

The base and/or the lid can include other indentations and/or protrusions that can form the same or other indicia.

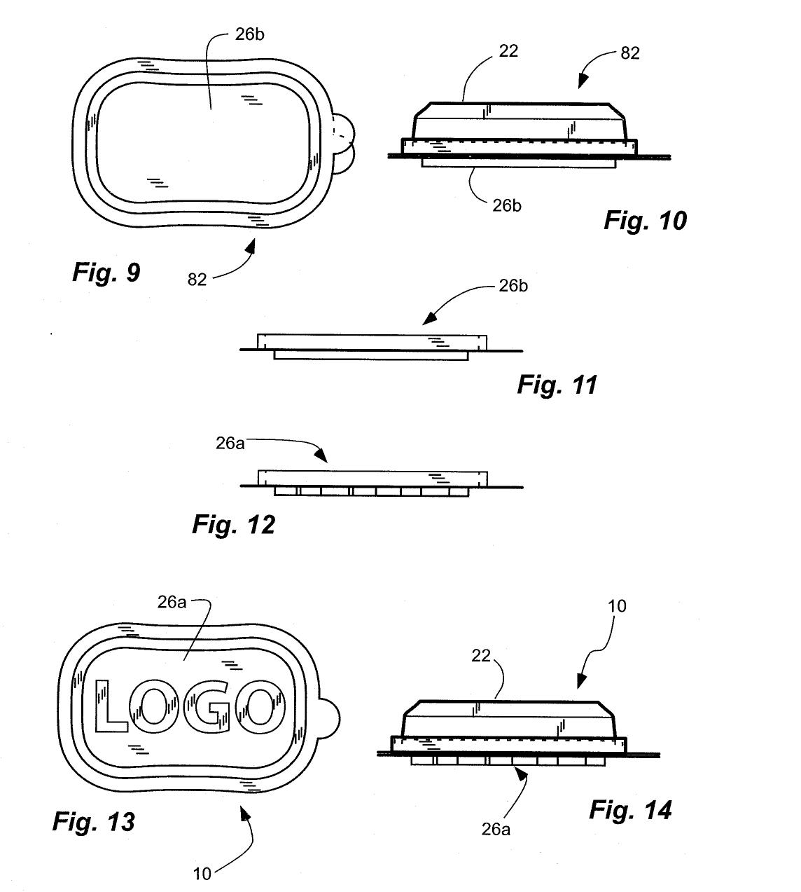

Referring to FIGS. 9-14, a method for making a promotional device 10 as described above includes obtaining a plurality of precursors 82. FIGS. 9 and 10 show bottom and side views, respectively, of the precursor 82. Each precursor can be similar to the promotional item described above, but with a blank base 26b, including: a container 14 having a lid 22 with a cavity 30 therein and an opening 34 therein to the cavity, and a blank base 26b coupled to the lid 22 and covering the cavity and closing the opening, the lid and the blank base forming a substantially air-tight compartment in the cavity and defining a volume therein. The lid 22 can include a release coating applied to an interior surface of the lid and the blank base. A moldable dough 18 is disposed in the volume of the container. A plurality of replacement bases 26a is embossed or debossed. Each replacement base 26a includes: a protrusion, an indentation, or both 58, formed in the replacement base and forming a three-dimensional indicia 62 indicative of or representing a business, a product, or both, and defining an interior negative mold 66 thereof on an interior of the replacement base, as shown in FIG. 12. The replacement base 26a can include a release coating applied to an interior surface of the replacement base. The blank base 26b is removed from each precursor 82, as shown in FIG. 11. Each lid 22 is closed with a different one of the plurality of replacement bases 26a to form the promotional item 10, as shown in FIGS. 13 and 14. In addition, each replacement base 26a can be pressed into the dough 18 to impart the interior negative mold of the replacement base into the dough to form an exterior positive impression 70 of the mold in the dough and thus a three-dimensional indicia 74 indicative of or representing the business, product, or both, in the dough (as shown in FIG. 7).

The moldable dough can be viewed through at least a portion of the lid, the base, or both, with the at least a portion of the lid, the base, or both being transparent.

Thus, logos or indicia 74 are molded into the dough using the clamshell packaging itself. The logo can be embossed or debossed in the packaging, causing the dough inside to deform to the shape of the logo when the clamshell is closed. Silicone oil or release coating can be applied to the interior side of the clamshell to prevent the dough from sticking to the PVC plastic clamshell. Additionally, the closure on the clamshell can have a small gap between lid and base (where the lid and base separate on the inside) such that the dough inside the clamshell can expand or contract in that gap, like a spillway, because different types of embossed logos will consume varying volumes of dough within the clamshell. Marketing via a sticker label may also be placed on the opposite side of the clamshell from the embossed logo, as well as by a hanging or string type tag from a hole through the finger tabs.

Although the container has been shown with a lid and one or more separate bases, the container can be formed by a single lid and a single base formed from a single sheet or web of plastic with a hinge (such as a living hinge) therebetween as a clamshell.

Although the container, or the lid and the base thereof, have been described as being formed of a single layer with substantially a single thickness such that the three-dimensional indicia 74 in the dough matches the three-dimensional indicia 62 of the base, the container, or the base thereof, can include more than one layer such that the base has differing thickness and such that the protrusions and/or indentations on the top of exterior of the base do not necessarily match those of the interior, or such that the exterior is flat while the interior has the protrusions and/or indentations.

Referring to FIG. 19, another promotional item 10b is shown that is similar in most respects to that described above, and which description is hereby incorporated herein by reference. The promotion item 10b includes a sticker or label 80 carried by an interior surface of the lid 22. The matching indicia can correspond to the three-dimensional indicia on the base. The indicia or sticker 80 can have an image or the indicia on an adhesive side of the sticker to face against the container or the lid and out of the cavity so that the image or indicia is visible on the outside of the lid or cavity (through the transparent lid). Thus, the sticker or label 80 is disposed in the cavity 30 between the dough 18 and the lid 22 or top thereof. The sticker or label 80 can have an inward facing side and an outward facing side. The sticker or label can have indicia on both the inward facing side, and the outward facing side, with the indicia on the outward facing side being visible through the lid.

Referring to FIGS. 20-22, another promotional item 10c is shown that is similar in most respects to those described above, and which description is hereby incorporated herein by reference. The promotion item 10c includes a protrusion, an indentation, or both 58c, formed in the lid 22c or top thereof, and forms a three-dimensional indicia 62c indicative of or representing a business (or company), a product, or both, such as a logo, and defines an interior negative mold thereof on an interior of the lid. The lid 22c can be closed by a base, such as the blank base 26b. In addition, a sticker or label 78 can be disposed on the base 26b. In another aspect, a sticker or label 80 can be disposed on an interior of the base 26b, and visible therethrough.

Referring to FIG. 23, another promotional item 10d is shown that is similar in most respects to those described above, and which description is hereby incorporated herein by reference. The promotion item 10d includes a base 26d with the protrusion, an indentation, or both 58d, forming a three-dimensional indicia 62c, is recessed into the perimeter or shell of the container or base 26d.

Referring to FIG. 24, another promotional item 10e is shown that is similar in most respects to those described above, and which description is hereby incorporated herein by reference. The promotion item 10e includes a lid 22e with the protrusion, an indentation, or both 58e, forming a three-dimensional indicia 62e, is recessed into the perimeter or shell of the container or lid 22e.

Referring to FIG. 25, another promotional item 10f is shown that is similar in most respects to those described above, and which description is hereby incorporated herein by reference. The promotion item 10f includes a lid 22f and a base 26f with the protrusion, an indentation, or both 58d, forming a three-dimensional indicia 62c, is recessed into the perimeter or shell of the container, or the lid and the base. The recessed indicia can create recessed indicia in the dough.

Referring to FIG. 26, another promotional item 10g is shown that is similar in most respects to those described above, and which description is hereby incorporated herein by reference. The promotion item 10g includes a lid 22g and a base 26g with the protrusion, an indentation, or both 58g, forming a three-dimensional indicia 62g, is protruding from the perimeter or shell of the container, or the lid and the base. The protruding indicia can create protruding indicia in the dough.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A promotional device, comprising:
a) a container having a lid with a cavity therein and an opening therein to the cavity;
b) a blank base coupled to the lid and covering the cavity and closing the opening, the lid and the base forming a substantially air-tight compartment in the cavity and defining a volume therein;
c) a replacement base, interchangeable with the blank base, and couplable to the lid and covering the cavity and closing the opening with the blank base removed, the lid and the replacement base forming another substantially air-tight compartment in the cavity and defining another volume therein;
d) a protrusion, an indentation, or both, formed in the replacement base and foaming a three-dimensional indicia indicative of or representing a business, a product, or both, and defining an interior negative mold thereof on an interior of the replacement base; and
e) a moldable dough disposed in and substantially filling the another volume of the container and abutting the interior negative mold of the replacement base to form an exterior positive impression of the mold in the dough and thus a three-dimensional indicia indicative of or representing the business, product, or both, in the dough.

2. A device in accordance with claim 1, wherein the blank base is free of a protrusion or an indentation forming a three-dimensional indicia.

3. A device in accordance with claim 1, wherein the dough is dryable in air to a rigid form.

4. A device in accordance with claim 1, further comprising:
a closure between the lid and the replacement base to secure the lid and the replacement base together and to form the substantially air-tight compartment, the closure including:
i) an indentation formed in one of the lid or the replacement base with an annular, inwardly-facing, perimeter wall;
ii) a protrusion formed in another of the lid or the replacement base with an annular, outwardly-facing, perimeter wall abutting to the perimeter wall of the indentation; and
iii) the protrusion having a depth less than a depth of the indentation creating a annular space between the protrusion and the indentation;

5. A device in accordance with claim 4, wherein the dough is pressed into the annular space between the protrusion and the indentation which defines an overflow volume for the dough.

6. A device in accordance with claim 1, further comprising:
a matching indicia carried by an exterior surface of the lid and corresponding to the three-dimensional indicia.

7. A device in accordance with claim 1, further comprising:
a release coating applied to an interior surface of the lid and the blank base and the replacement base.

8. A device in accordance with claim 1, wherein at least a portion of the lid, the replacement base, or both are transparent.

9. A device in accordance with claim 1, further comprising:
the lid being transparent;
a label disposed in the cavity between the dough and the lid and having an inward facing side and an outward facing side; and
the label having indicia on both the inward facing side, and the outward facing side, with the indicia on the outward facing side being visible through the lid.

10. A method for making a promotional device, comprising:
a) obtaining a plurality of precursors, each precursor including:
i) a container having a lid with a cavity therein and an opening therein to the cavity, and a blank base coupled to the lid and covering the cavity and closing the opening, the lid and the blank base forming a substantially air-tight compartment in the cavity and defining a volume therein;
ii) a moldable dough disposed in the volume of the container;
b) embossing or debossing a plurality of replacement bases, each replacement base including:
i) a protrusion, an indentation, or both, formed in the replacement base and forming a three-dimensional indicia indicative of or representing a business, a product, or both, and defining an interior negative mold thereof on an interior of the replacement base;
c) removing the blank base from each precursor; and
d) closing each lid with a different one of the plurality of replacement bases and pressing each replacement base into the dough to impart the interior negative mold of the replacement base into the dough to form an exterior positive impression of the mold in the dough and thus a three-dimensional indicia indicative of or representing the business, product, or both, in the dough.

11. A method in accordance with claim 10, wherein the blank base is free of a protrusion or an indentation forming a three-dimensional indicia.

12. A method in accordance with claim 10, wherein the dough is dryable in air to a rigid form.

13. A method in accordance with claim 10, further comprising:
a closure between the lid and the replacement base to secure the lid and the replacement base together and to form the substantially air-tight compartment, the closure including:
i) an indentation formed in one of the lid or the replacement base with an annular, inwardly-facing, perimeter wall;
ii) a protrusion formed in another of the lid or the replacement base with an annular, outwardly-facing, perimeter wall abutting to the perimeter wall of the indentation; and
iii) the protrusion having a depth less than a depth of the indentation creating a annular space between the protrusion and the indentation;

14. A method in accordance with claim 13, wherein the dough is pressed into the annular space between the protrusion and the indentation which defines an overflow volume for the dough.

15. A method in accordance with claim 13, further comprising:
a matching indicia carried by an exterior surface of the lid and corresponding to the three-dimensional indicia.

16. A method in accordance with claim 13, further comprising:
a release coating applied to an interior surface of the lid and the blank base and the replacement base.

17. A method in accordance with claim 13, further comprising:
viewing the moldable dough through at least a portion of the lid, the base, or both, with the at least a portion of the lid, the replacement base, or both being transparent.

18. A method in accordance with claim 13, further comprising:
the lid being transparent;
a label disposed in the cavity between the dough and the lid and having an inward facing side and an outward facing side; and
the label having indicia on both the inward facing side, and the outward facing side, with the indicia on the outward facing side being visible through the lid.

19. A promotional device, comprising:
a) a container having a lid with a cavity therein and an opening therein to the cavity;
b) a blank base coupled to the lid and covering the cavity and closing the opening, the lid and the base forming a substantially air-tight compartment in the cavity and defining a volume therein;
c) a replacement base, interchangeable with the blank base, and couplable to the lid and covering the cavity and closing the opening with the blank base removed, the lid and the replacement base forming another substantially air-tight compartment in the cavity and defining another volume therein;
d) a protrusion, an indentation, or both, formed in the replacement base and forming a three-dimensional indicia indicative of or representing a business, a product, or both, and defining an interior negative mold thereof on an interior of the replacement base;
e) a moldable dough disposed in and substantially filling the another volume of the container and abutting the interior negative mold of the replacement base to form an exterior positive impression of the mold in the dough and thus a three-dimensional indicia indicative of or representing the business, product, or both, in the dough;
f) a closure between the lid and the replacement base to secure the lid and the replacement base together and to form the substantially air-tight compartment, the closure including:
i) an indentation formed in one of the lid or the replacement base with an annular, inwardly-facing, perimeter wall;
ii) a protrusion formed in another of the lid or the replacement base with an annular, outwardly-facing, perimeter wall abutting to the perimeter wall of the indentation; and
iii) the protrusion having a depth less than a depth of the indentation creating a annular space between the protrusion and the indentation;
g) the dough is pressed into the annular space between the protrusion and the indentation which defines an overflow volume for the dough;
h) a release coating applied to an interior surface of the lid and the replacement base;
i) at least a portion of the lid, the replacement base, or both being transparent;
j) the moldable dough being visible through the at least a portion of the lid, the replacement base, or both;
k) the moldable dough having at least two locations, including:
i) an enclosed location in which the dough is disposed in the container; and
ii) a removed location in which the dough is removed out of the container; and
l) the moldable dough being pliable and having at least two configurations, including:
i) a molded configuration in which the dough has the three-dimensional indicia; and
ii) a random configuration in which the dough has a random configuration without the three-dimensional indicia.

20. A device in accordance with claim 19, further comprising:
the lid being transparent;
a label disposed in the cavity between the dough and the lid and having an inward facing side and an outward facing side; and
the label having indicia on both the inward facing side, and the outward facing side, with the indicia on the outward facing side being visible through the lid.

21. A promotional device, comprising:
a) a container;
b) a protrusion, an indentation, or both, formed in the container and forming a three-dimensional indicia indicative of or representing a business, a product, or both, and defining an interior negative mold thereof on an interior of the container; and
c) a moldable dough disposed in the container and abutting the interior negative mold of the base to form an exterior positive impression of the mold in the dough and thus a three-dimensional indicia indicative of or representing the business, product, or both, in the dough.
